(19) United States
(12) Patent Application Publication
(10) Pub. No.: US 2011/0202873 A1
(43) Pub. Date: Aug. 18, 2011

(54) MENU LAUCHING STRUCTURE

(75) Inventors: Michael N. Tofinetti, Kanata (CA); Katha Kulasingam, Kanata (CA)

(73) Assignee: ALCATEL-LUCENT CANADA INC., Ottawa (CA)

(21) Appl. No.: 12/707,845

(22) Filed: Feb. 18, 2010

(51) Int. Cl. G06F 3/048

(52) U.S. Cl. 715/810; 715/764

(57) ABSTRACT

A method is provided for acting on a selected menu item. The menu items are defined so as to have associated with them a label, a launch type, and a parameter. Depending on the launch type of a selected menu item, different actions are taken and the parameter is used in different ways. If the launch type indicates that a list or a form is to be presented upon selection of a menu item, then the parameter is passed as an input to a list or form subsystem. If the launch type indicates that an action specific to the selected menu item is to be performed, then a pre-defined function within an object representing the entity indicated by the selected menu item is called, the name of the pre-defined function being determined from the value of the parameter. The method of defining and acting on menu items allows both common functions and functions specific to a menu item to be associated with menu items.

### FIELD OF THE INVENTION

This invention relates to menu structures, and in particular actions to be taken upon selection of a menu item.

### BACKGROUND OF THE INVENTION

When an item is selected from a menu, an action associated with the menu item is launched directly. This does not take advantage of functions common to several items in the menu. This also fails to take into account the current state of the system.

A structure for defining a menu would preferably associate numerous variables with the menu items, and selection of a menu item would execute any of various functions, some of which may be common subsystems, depending on the variables associated with the menu items.

### SUMMARY OF THE INVENTION

According to one aspect, the invention provides a method of responding to selection of a menu item. A launch type of the menu item is determined, the launch type being associated with the menu item in a definition of the menu item. If the launch type indicates that a list is to be presented, a list subsystem is invoked and the value of a parameter associated with the menu item in the definition of the menu item is passed as an input to the list subsystem. If the launch type indicates that a form is to be presented, a form subsystem is invoked and the value of the parameter is passed as an input to the form subsystem. If the launch type indicates that a custom action is to be performed, a custom action defined by the value of the parameter is invoked.

According to another aspect, the invention provides a method of defining a menu. For each of a plurality of menu items, a value of a label is stored in association with the menu item. For each of the plurality of menu items, a value of a launch type is stored in association with the menu item. For each of the plurality of menu items, a value of a parameter is stored in association with the menu item.

The methods of the invention may be stored as processing instructions on computer-readable storage media, the instructions being executable by a computer processor.

The invention allows different actions to be performed on selected menu items, depending on a launch type of the item included in the definition of the menu item. The structure of the definition of the menu items also stores a parameter for use when performing the defined action type. For some launch types, the parameter is an input to a common subsystem. For other launch types, the parameter is a class name of an object, with a specific action defined for the object.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of an example menu definition according to one embodiment of the invention; and

FIG. 2 is a flowchart of a method executed upon selection of a menu end item according to one embodiment of the invention.

It is noted that in the attached figures, like features bear similar labels.

### DETAILED DESCRIPTION OF THE PREFERRED EMBODIMENTS

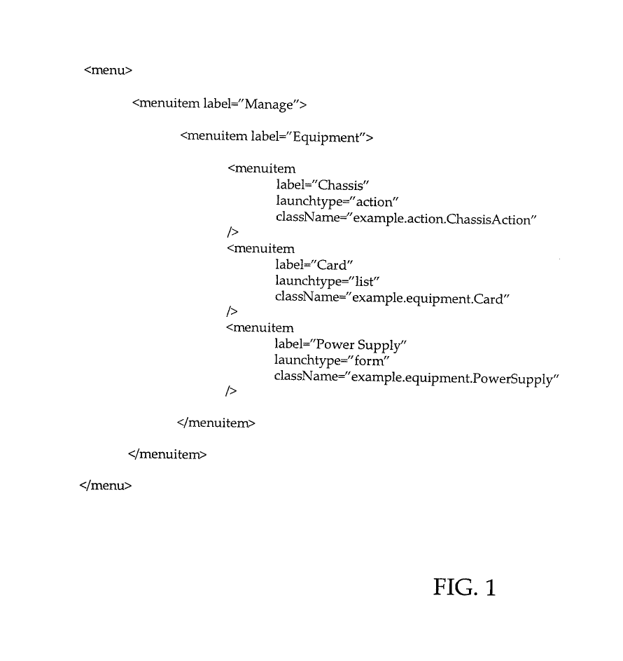

Referring to FIG. 1, a diagram of an example menu definition according to one embodiment of the invention is shown. FIG. 1 shows the contents of an XML file in which a menu is defined. The example menu shown in FIG. 1 has several layers, selection of menu items in some layers (for example, the menu item labeled “Equipment”) making submenus accessible to a user. Ultimately end menu items are presented, selection of which performs some task other than opening a submenu. The menu shown in FIG. 1 contains three menu end items, each indicated by a value of a label variable named “label”. The three menu end items in the menu and available for selection by a user are “Chassis”, “Card”, and “Power Supply”. Each menu end item also has a launch type variable named “launchtype”. The value of the “launchtype” variable for the “Chassis” menu item is “action”. The value of the “launchtype” variable for the “Card” menu item is “list”. The value of the “launchtype” variable for the “Power Supply” menu item is “form”. Each menu item also has a parameter variable named “className”. The value of the “className” variable for the “Chassis” menu item is “example.action.ChassisAction”. The value of the “className” variable for the “Card” menu item is “example.equipment.Card”. The value of the “className” variable for the “Power Supply” menu item is “example.equipment.PowerSupply”.

The menu described with reference to FIG. 1 is an example only. In general, the menu will be defined to have a structure in which each end item has associated with it at least three variables, one of the variables being a label, one of the variables being a launch type, and one of the variables being a parameter used in executing an action.

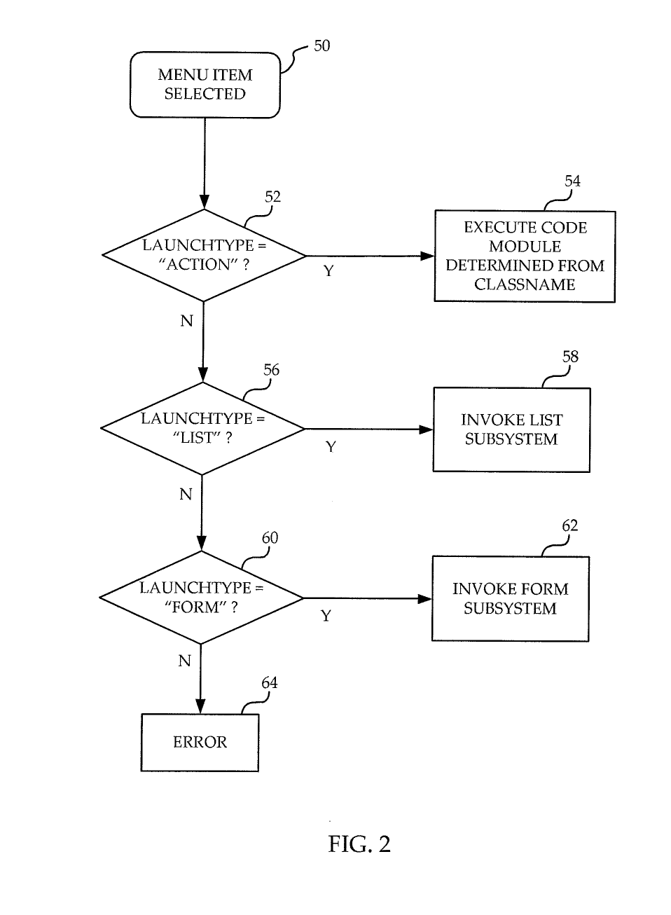

Referring to FIG. 2, a flowchart of a method executed upon selection of a menu end item according to one embodiment of the invention is shown. The method starts when a menu end item is selected 50 from a menu. At step 52 it is determined whether the value of the variable “launchtype” of the selected item is equal to “action”. If so, then a code module is executed at step 54. The code module is within an object whose class and name is derived from the value of the variable “className”. The name of the code module is pre-defined and therefore known upon selection of the menu item. The logic within the code module can perform any defined task. For example, the code can consult the current state of the system, determine the information currently defined for the entity represented by the selected menu item (as determined from the value of “className”), and launch either a list or a form depending on whether the entity currently needs further configuration.

If the value of the variable “launchtype” of the selected item is not equal to “action”, then at step 56 it is determined whether the value of the variable “launchtype” of the selected item is equal to “list”. If so, then at step 58 a list subsystem is invoked, using the value of “className” as an input to the list subsystem. The list subsystem determines the specific type of List window to open using the value of “className”. Using the value of “className”, the list subsystem determines the type of entity selected and determines the format of the list. The format of the list is pre-defined within the list subsystem for all entity types, along with information about performing searches for the type of entity indicated by the value of “className”. The format is preferably stored as a text file in XML format which describes the layout of the contents of the List window. The information contained in the list subsystem includes data to be displayed as well as filters to be applied. Using the value of “className”, the list subsystem also determines the specific entity referred to by the selected menu item, both the entity type and specific entity derivable from the value of “className”. The list subsystem opens a List window, preferably directly into the display manager for the application from which the menu was accessed, and populates the List window with current data for the specific entity.

If the value of the variable “launchtype” of the selected item is not equal to “list”, then at step 60 it is determined whether the value of the variable “launchtype” of the selected item is equal to “form”. If so, then at step 62 a form subsystem is invoked, using the value of “className” as an input to the form subsystem. The form subsystem determines the specific type of Form window to open using the value of “className”. Using the value of “className”, the form subsystem determines the type of entity selected and determines the format of the form. The format of the form is pre-defined within the form subsystem for all entity types. The format is preferably stored as a text file in XML format which describes the layout of the contents of the Form window. Using the value of “className”, the form subsystem also determines the specific entity referred to by the selected menu item, both the entity type and specific entity derivable from the value of “className”. The form subsystem opens a Form window, preferably directly into the display manager for the application from which the menu was accessed.

If the value of the variable “launchtype” of the selected item is not equal to “form”, then the variable “launchtype” has an unrecognized value and an error occurs at step 64. Ideally this should not happen because when the method described with reference to FIG. 2 is compiled the unrecognized value of the “launchtype” variable will be detected. However, an error may be processed at step 64 for completeness or as a safeguard. The actions to be taken upon occurrence of the error are not within the scope of this application, but may be simply presentation of an error message.

As an alternative, other launch types and their associated actions can be defined and included in the menu definition. The use of the value of the variable “className” will depend on the logic performed for the launch type. A graph launch type and subsystem, a map launch type and subsystem, and a tree launch type and subsystem are examples. In the example of a graph launch type, for example, the method described above with reference to FIG. 2 can be modified so that it is determined whether the value of “launchtype” is equal to “graph”. If so, then a graph subsystem is invoked using the value of “className” as an input parameter.

Broadly, when a menu item is selected, the launch type defined for the menu item is determined, and an action taken based on the launch type. If the launch type indicates that a custom action is to be performed, then a parameter defined for that menu item is used to invoke the custom action. If the launch type indicates that a list is to be displayed for the menu item, then a list subsystem is invoked using the parameter defined for that menu item as an input. If the launch type indicates that a form is to be displayed for the menu item, then a form subsystem is invoked using the parameter defined for that menu item as an input. Other launch types and their associated actions may also be defined.

The logic of the methods is preferably in the form of software, and may be stored as instructions on computer-readable storage media which can cause a computer processor to act upon selection of a menu end item. The definition of a menu, including associations of labels, launch types, and parameters for menu items, may be stored on computer-readable storage media which can cause a computer processor to present a menu.

The embodiments presented are exemplary only and persons skilled in the art would appreciate that variations to the embodiments described above may be made without departing from the spirit of the invention. For example, the menu may be defined using other means than an XML file. As another example, the order in which the value of the “launchtype” variable is determined may be varied, and the method may be any method which is logically equivalent to that described above with reference to FIG. 2. Other values of the “launchtype” variable can be used. The scope of the invention is solely defined by the appended claims.

I/we claim:

1. A method of responding to selection of a menu item, comprising:
determining a launch type of the menu item, the launch type associated with the menu item in a definition of the menu item;
if the launch type indicates that a list is to be presented, invoking a list subsystem and passing the value of a parameter associated with the menu item in the definition of the menu item as an input to the list subsystem;
if the launch type indicates that a form is to be presented, invoking a form subsystem and passing the value of the parameter as an input to the form subsystem; and
if the launch type indicates that a custom action is to be performed, invoking a custom action defined by the value of the parameter.

2. The method of claim 1 wherein the list subsystem determines a format of the list from the parameter, and wherein the form subsystem determines a format of the form from the parameter.

3. The method of claim 1 further comprising invoking a different subsystem and passing the value of the parameter as an input to the different subsystem if the launch type indicates that the different subsystem is to be invoked.

4. The method of claim 3 wherein the launch type indicates that a graph subsystem is to be invoked.

5. The method of claim 3 wherein the launch type indicates that a map subsystem is to be invoked.

6. The method of claim 3 wherein the launch type indicates that a tree subsystem is to be invoked.

7. The method of claim 1 wherein the definition of the menu item is stored in an XML file.

8. A method of defining a menu, comprising:
for each of a plurality of menu items, storing a value of a label in association with the menu item;
for each of the plurality of menu items, storing a value of a launch type in association with the menu item; and
for each of the plurality of menu items, storing a value of a parameter in association with the menu item.
